(19) United States
(12) Patent Application Publication
(10) Pub. No.: US 2022/0356986 A1
(43) Pub. Date: Nov. 10, 2022

(54) Display Support Having Freely Adjustable Height

(71) Applicant: NINGBO TUOTUO RIVER DESIGN COMPANY, NINGBO (CN)

(72) Inventors: Xiaodong YOU, NINGBO (CN); Yujie ZHENG, NINGBO (CN)

(21) Appl. No.: 17/866,546

(22) Filed: Jul. 17, 2022

Related U.S. Application Data
(63) Continuation of application No. PCT/CN2021/088201, filed on Apr. 19, 2021.

(30) Foreign Application Priority Data
Apr. 20, 2020 (CN) 202020590439.5
Jun. 28, 2020 (CN) 202010599396.1
Jul. 19, 2021 (CN) 202121639040.2

(51) Int. Cl. F16M 11/24

(52) U.S. Cl. CPC F16M 11/24

(57) ABSTRACT

A display support having a freely adjustable height, including a base and a connector for installing a display, wherein an upper connecting arm and a lower connecting arm, which are parallel to each other, are arranged between the base and the connector. The display support further includes a mechanical spring, wherein an end of the mechanical spring is hinged with the connector or the lower connecting arm, the other end of the mechanical spring is hinged with a threaded sliding block, the threaded sliding block sleeves on a threaded rod, the threaded rod is arranged in the base, so that when an end part of the threaded rod is operated to drive the threaded rod to rotate, the threaded sliding block moves along the threaded rod, and a position of the threaded sliding block on the threaded rod is adjusted according to the weight of the display on the connector, so that when the connector is moved upwards or downwards, the connector is stopped at different heights relative to the base. The display support having the freely adjustable height can realize free stop of height adjustment, and thus is better than an air spring support.

### CROSS-REFERENCE TO RELATED APPLICATION

The present disclosure claims the priority of Chinese Application No. 202010599396.1, filed in the Chinese Patent Office on Jun. 28, 2020, and entitled “Display Support Having Freely Adjustable Height”, the priority of Chinese Application No. 202020590439.5, filed in the Chinese Patent Office on Apr. 20, 2020, and entitled “Display Support Having Freely Adjustable Height”, and the priority of Chinese Application No. 202121639040.2, filed in the Chinese Patent Office on Jul. 19, 2021, and entitled “Balance device for realizing adjustable load-bearing of a support”, the entire contents of which are herein incorporated by reference.

### TECHNICAL FIELD

The present disclosure relates to the technical field of display supports, and relates to a display support having a freely adjustable height.

### BACKGROUND

In a related art, a display support having a freely adjustable height mainly uses an air spring structure or a mechanical spring structure to realize height adjustment. An air spring display support has the disadvantages of high cost, short life, hidden danger of oil leakage, potential safety hazards, and non-environmental protection (due to disposal difficulty after being scrapped), but has a stable air spring force, thereby having better experience in free height adjustment. The air spring display support still dominates at present.

A mechanical spring display support has the advantages of low cost, long life, safety and environmental protection, etc. However, the free height adjustment of mechanical spring display known to inventors relies too much on friction to achieve balance, such that the experience is worse.

Therefore, there is a need for a mechanical spring display support that provides an experience comparable to, or even better than, the air spring support in terms of free height adjustment.

### SUMMARY

Some embodiments of the present disclosure solve the above problems, and provide a mechanical spring type display support that is convenient to install and can be stopped after height adjustment.

According to one aspect of the embodiments of the present disclosure, a display support having a freely adjustable height is provided. The display support includes a base and a connector for installing a display, an upper connecting arm and a lower connecting arm, which are parallel to each other, are arranged between the base and the connector, and a quadrilateral structure is formed among a hinge point between the upper connecting arm and the connector, the connector, a hinge point between the lower connecting arm and the connector, the lower connecting arm, a hinge point between the lower connecting arm and the base, the base, a hinge point between the upper connecting arm and the base, and the upper connecting arm; and

the display support further includes a mechanical spring, wherein an end of the mechanical spring is hinged with the connector or the lower connecting arm, an other end of the mechanical spring is hinged with a threaded sliding block, the threaded sliding block sleeves on a threaded rod, the threaded rod is arranged in the base, so that when an end part of the threaded rod is operated to drive the threaded rod to rotate, the threaded sliding block is movable along the threaded rod, and a position of the threaded sliding block on the threaded rod is adjusted according to a weight of the display on the connector, so that when the connector is moved upwards or downwards, the connector is stopped at different heights relative to the base.

In the display support having the freely adjustable height according to the embodiments of the present disclosure, free stop of height adjustment is realized by using the mechanical spring, and thus is better than an air spring support.

In some embodiments, the display support satisfies a first balance condition and a second balance condition, and the first balance condition is: maintaining the connector at any height within a preset height range, driving the threaded sliding block to move by driving the threaded rod to rotate, and ensuring that a gravitational torque M1 is equal to an elastic torque M2, so as to adapt to the display of any weight within a preset weight range; and the second balance condition is: according to the first balance condition, maintaining a position of the threaded sliding block corresponding to the weight of the display in the threaded rod, and when the height of the connector is arbitrarily changed within the preset height range, ensuring that the gravitational torque M1 is equal to the elastic torque M2, so that the connector is able to stop at different heights relative to the base.

In some embodiments, the threaded rod is set to be consistent with a movement trajectory of the threaded sliding block, the movement trajectory of the threaded sliding block is a line segment formed by connecting a point e₀ and a point f₀ within a range of a quadrilateral e₁f₁f₂e₂, the range of the quadrilateral e₁f₁f₂e₂ is formed by translating the line segment ef upwards and downwards for 5 mm in a direction perpendicular to the line segment ef, so as to obtain line segments e₁f₁ and e₂f₂ respectively, a point e and a point f are respectively intersection points of a circle C with a straight line La and a straight line Lb, a connecting point between the mechanical spring and the connector or the lower connecting arm is taken as a center of circle of the circle C, a length L1 of the mechanical spring when the connector is at a preset maximum height is taken as a radius of the circle C, and the straight lines La and Lb are respectively straight lines where the mechanical spring is located when an included angle b between the mechanical spring and the upper connecting arm or the lower connecting arm is at a maximum value and a minimum value.

In some embodiments, an included angle between the threaded rod and a horizontal direction away from the connector is 0-80°.

In some embodiments, when the connector is at a preset maximum height, a length L₁ of the mechanical spring is set to be L-x, wherein L represents a distance from a connecting point between the mechanical spring and the connector or the lower connecting arm to a hinge point between the lower connecting arm and the base, and x is −10 mm-30 mm.

In some embodiments, Mien the connector is maintained at any horizontal height within a preset height range, according to a maximum value and a minimum value of the preset weight range of the display, a maximum value and a minimum value of an included angle b between the mechanical spring and the upper connecting arm or the lower connecting arm are obtained.

In some embodiments, an elastic coefficient K of the mechanical spring is Kmin−Kmax, wherein Kmax−Kmin≤15, and Kmin and Kmax are obtained by a following formula:

$$K = ( \frac{G cos ( a 1 )}{sin ( b 1 )} - \frac{G cos ( a 2 )}{sin ( b 2 )} ) / ( L 1 - L {1}^{′} )$$

in the formula, G represents a weight of the display;

a1 and a2 respectively represent angles between the upper connecting arm or the lower connecting arm and a horizontal plane Men the connector is at two arbitrary heights within a preset height range;

b1 and b2 respectively represent included angles between the mechanical spring corresponding to a1, a2 and the upper connecting arm or the lower connecting arm; and

L1 and L1′ respectively represent lengths of the mechanical spring corresponding to a1 and a2.

In some embodiments, an end of the threaded rod is set to be an operating end, and an other end of the threaded rod is rotatably arranged in a mounting seat, so that the threaded rod is driven to rotate by applying a force to the operating end.

In some embodiments, the display support includes an adjusting rod, an end of the adjusting rod is hinged with the connector or the lower connecting arm, an other end of the adjusting rod is in threaded connection with the end of the mechanical spring, and when an end part of the adjusting rod is operated to drive the adjusting rod to rotate, the mechanical spring is driven to expand and contract, so as to adjust an elastic force of the mechanical spring and adapt to the display within a preset weight range.

According to another aspect of the embodiments of the present disclosure, a display support having a freely adjustable height is provided. The display support includes a base and a connector for installing a display, an upper connecting arm and a lower connecting arm, which are parallel to each other, are arranged between the base and the connector, a parallelogram structure is formed among a hinge point between the upper connecting arm and the connector, the connector, a hinge point between the lower connecting arm and the connector, the lower connecting arm, a hinge point between the lower connecting arm and the base, the base, a hinge point between the upper connecting arm and the base, and the upper connecting arm, the display support further includes an elastic force balance mechanism, an end of the elastic force balance mechanism is hinged with the upper connecting arm, an other end of the elastic force balance mechanism is hinged with the connector, and an elastic force of the elastic force balance mechanism is adjusted according to the display on the connector, so that when the connector is moved upwards or downwards, the connector is stopped at different heights relative to the base.

In some embodiments, the elastic force balance mechanism includes an elastic member and an adjusting rod, one end of the adjusting rod is hinged with the upper connecting arm, the other end of the adjusting rod is in threaded connection with one end of the elastic member, the other end of the elastic member is connected to the connector, and when the end part of the adjusting rod is operated to drive the adjusting rod to rotate, the elastic member is driven to expand and contract, so as to make the elastic force of the elastic member match the weight of the display on the connector.

In some embodiments, an end part of the upper connecting arm is provided with an operating hole, the end part of the adjusting rod is installed in the operating hole, and the end part of the adjusting rod is operated by the operating hole.

In some embodiments, both the upper connecting arm and the lower connecting arm are respectively hinged with the base and the connector by connecting shafts and shaft holes matching the connecting shafts.

By using the display support having the freely adjustable height in the present disclosure, and on the basis of the configuration position of the elastic force balance mechanism relative to the parallelogram structure, free stop during height adjustment can be realized. Moreover, the display support has few parts, a simple structure, a lower cost and a beautiful appearance.

Some embodiments of the present disclosure overcome the shortcomings of the above-mentioned art known to inventors, and provide a balance device for realizing adjustable load-bearing of a support, which satisfies low cost, high life, stable performance, safety and environmental protection.

In some embodiments, the balance device for realizing adjustable load-bearing of the support is as follows:

The balance device for realizing adjustable load-bearing of the support includes a base, a mechanical spring and a connector for installing a display, an upper arm plate and a lower arm plate are arranged between the base and the connector, a quadrilateral structure is formed among a hinge point between the upper arm plate and the connector, the connector, a hinge point between the lower arm plate and the connector, the lower arm plate, a hinge point between the lower arm plate and the base, the base, a hinge point between the upper arm plate and the base, and the upper arm plate, and an end of the mechanical spring is hinged with the base.

In some embodiments, the device further includes a threaded sliding block and a threaded rod, the other end of the mechanical spring is hinged with the threaded sliding block, the threaded sliding block sleeves on the threaded rod, the threaded rod is installed on the connector, and when an end part of the threaded rod is operated to drive the threaded rod to rotate, the threaded sliding block is movable along the threaded rod.

In some embodiments, a position of the threaded sliding block on the threaded rod is adjustable according to a weight of the display connected with the connector, so that when the connector is moved upwards or downwards, the connector is adjusted to stop at different heights relative to the base.

In some embodiments, the lower arm plate is provided with a convex block, and the upper arm plate is provided with a groove corresponding to the convex block.

In some embodiments, the device further includes threads and a locking screw, the other end of the mechanical spring is hinged with the connector or the lower arm plate, the locking screw is matched with the threads, the threads are arranged in hinge holes of the upper arm plate or the lower arm plate and the base or the connector, and a hinge manner between the upper arm plate and the base, between the upper arm plate and the connector, between the lower arm plate and the base, and between the lower arm plate and the connector is a locking screw connection, or a riveting connection.

By using the balance device for realizing adjustable load-bearing of the support provided by some embodiments of the present disclosure, a mechanical spring type support is provided, in which an adjustment mechanism is arranged on a rear side, and which is convenient to adjust, can realize free stop at different load-bearing heights, and has better experience. The embodiments break through the limitation of conventional appearance, so that the shape can be more novel.

Moreover, an air spring known to inventors is replaced with the mechanical spring, which is lower in cost, and is safer, more stable and more reliable than an air spring support.

### BRIEF DESCRIPTION OF THE DRAWINGS

To illustrate technical solutions in the embodiments of the present disclosure and in the prior art more clearly, a brief introduction on the drawings which are needed in the description of the embodiments and the prior art is given below. Apparently, the drawings in the description below are merely some of the embodiments of the present disclosure, based on which other drawings can be obtained by those of ordinary skill in the art without any creative effort.

FIG. 1 is an exploded schematic diagram of a display support having a freely adjustable height according to some embodiments of the present disclosure.

FIG. 2 is a cross-sectional view of a first state of the display support having the freely adjustable height according to some embodiments of the present disclosure.

FIG. 3 is a cross-sectional view of a second state of the display support having the freely adjustable height according to some embodiments of the present disclosure.

FIG. 4 is a first simplified diagram of the display support having the freely adjustable height according to some embodiments of the present disclosure.

FIG. 5 is a second simplified diagram of the display support having the freely adjustable height according to some embodiments of the present disclosure.

FIG. 6 is another structural schematic diagram of the display support having the freely adjustable height according to some embodiments of the present disclosure FIG. 7 is a third structural schematic diagram of the display support having the freely adjustable height according to some embodiments of the present disclosure.

FIG. 8 is another exploded schematic diagram of the display support having the freely adjustable height according to some embodiments of the present disclosure.

FIG. 9 is a cross-sectional view of a first position of the display support having the freely adjustable height according to some embodiments of the present disclosure.

FIG. 10 is a simplified diagram of the display support having the freely adjustable height shown in FIG. 9.

FIG. 11a is a cross-sectional view of a second position of the display support having the freely adjustable height according to some embodiments of the present disclosure.

FIG. 11b is a simplified diagram of the display support having the freely adjustable height shown in FIG. 11a.

FIG. 12a is a cross-sectional view of a third position of the display support having the freely adjustable height according to some embodiments of the present disclosure.

FIG. 12b is a simplified diagram of the display support having the freely adjustable height shown in FIG. 12a.

FIG. 13 is an exploded structural diagram of a balance device for realizing adjustable load-bearing of a support in an embodiment of the present disclosure.

FIG. 14 is a schematic diagram of a threaded sliding block of the balance device for realizing adjustable load-bearing of the support in an embodiment of the present disclosure.

FIG. 15 is a schematic structural diagram of the prior art in which an adjustment mechanism cannot be arranged on the front side.

FIG. 16 is a schematic diagram of a two-dimensional coordinate system of the balance device for realizing adjustable load-bearing of the support in an embodiment of the present disclosure, in which a hinge point between a base and a lower arm is taken as a coordinate origin.

FIG. 17 is a schematic diagram of a threaded sliding block at a lowest point of the balance device for realizing adjustable load-bearing of the support in an embodiment of the present disclosure.

FIG. 18 is a schematic diagram of the threaded siding block at a middle point of the balance device for realizing adjustable load-bearing of the support in an embodiment of the present disclosure.

FIG. 19 is a schematic diagram of the threaded sliding block at a highest point of the balance device for realizing adjustable load-bearing of the support in an embodiment of the present disclosure.

FIG. 20 is a schematic diagram of flat placement of the balance device for realizing adjustable load-bearing of the support in an embodiment of the present disclosure.

FIG. 21 is a schematic diagram of downward placement of the balance device for realizing adjustable load-bearing of the support in an embodiment of the present disclosure.

FIG. 22 is a stereogram of the balance device for realizing adjustable load-bearing of the support in the present disclosure.

FIG. 23 is a schematic diagram of a second structure of the balance device for realizing adjustable load-bearing of the support in the present disclosure.

FIG. 24 is an exploded schematic diagram of the second structure of the balance device for realizing adjustable load-bearing of the support in the present disclosure.

FIG. 25 is a schematic diagram of a locking screw of the balance device for realizing adjustable load-bearing of the support in an embodiment of the present disclosure.

### DETAILED DESCRIPTION OF THE EMBODIMENTS

In order that the purposes, technical solutions and advantages of the present disclosure are clearer, a further detailed description of the present disclosure will be given below with reference to the drawings and in combination with embodiments. Apparently, the embodiments described below are merely a part, but not all, of the embodiments of the present disclosure. All of other embodiments, obtained by those of ordinary skill in the art based on the embodiments in the present disclosure without any creative effort, fall into the protection scope of the present disclosure.

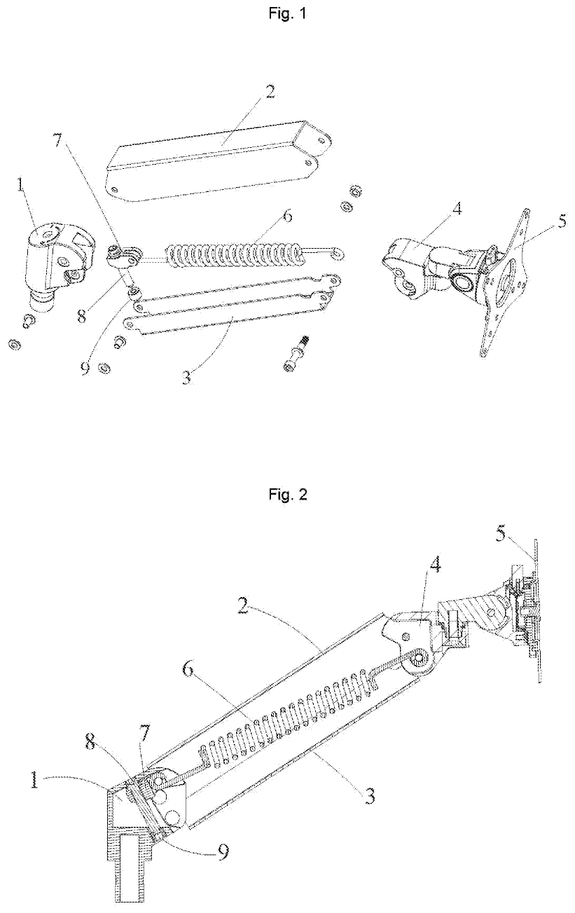

As shown in FIG. 1 to FIG. 6, one aspect of the embodiments of the present disclosure provides a display support with a freely adjustable height, wherein the display support includes a base 1 and a connector 4 for installing a display, the display is fixed to the connector 4 by a mounting plate 5, the display support further includes an upper connecting arm 3 and a lower connecting arm 3, which are parallel to each other, are arranged between the base 1 and the connector 4, and as shown in FIG. 4, a quadrilateral structure ABDC is formed among a hinge point C between the upper connecting arm 2 and the connector 4, the connector 4, a hinge point D between the lower connecting arm 3 and the connector 4, the lower connecting arm 3, a hinge point B between the lower connecting arm 3 and the base 1, the base 1, a hinge point A between the upper connecting arm 2 and the base 1, and the upper connecting arm 2.

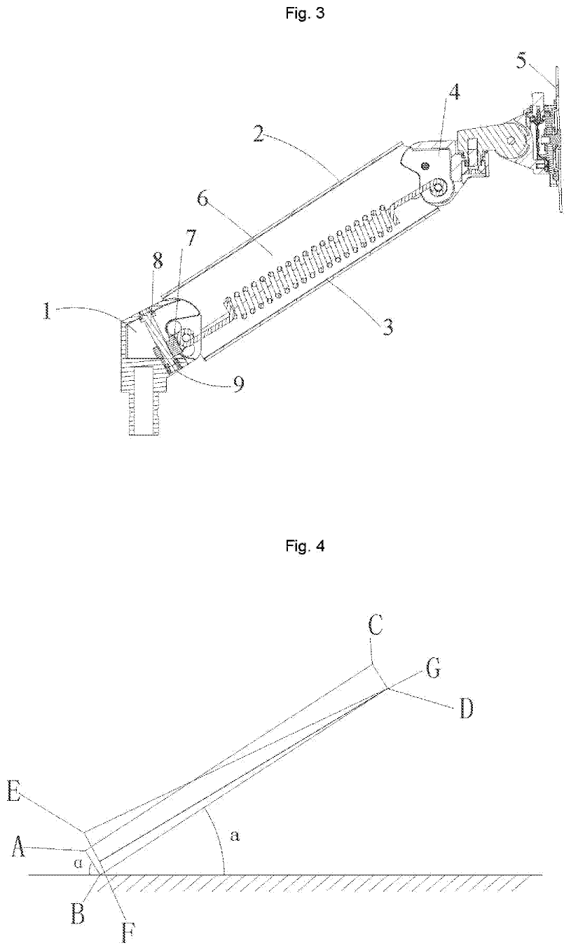

As shown in FIG. 1 to FIG. 3, the display support further includes a mechanical spring 6, one end of the mechanical spring 6 is hinged with the connector 4, the other end of the mechanical spring 6 is hinged with a threaded sliding block 7, the threaded sliding block 7 sleeves on a threaded rod 8, and the threaded rod 8 is arranged in the base 1. In some embodiments, one end of the threaded rod 8 is set to be an operating end 9, and the other end of the threaded rod 8 is rotatably arranged in the base 1, so that the threaded rod 8 is driven to rotate by applying a force to the operating end 9 of the threaded rod 8. When an end part of the threaded rod 8 is operated to drive the threaded rod 8 to rotate, the threaded sliding block 7 moves along the threaded rod 8. As shown in FIG. 2, at this time, the threaded sliding block 7 is at a highest end of the threaded rod 8; and as shown in FIG. 3, the threaded sliding block 7 is at a lowest end of the threaded rod 8, and the threaded sliding block 7 is movable between the highest end and the lowest end of the threaded rod 8 by operating the threaded rod 8.

The position of the threaded sliding block 7 on the threaded rod 8 is adjusted according to the weight of the display on the connector 4, so that when the connector 4 is moved upwards or downwards, the connector 4 is stopped at different heights relative to the base 1.

In some embodiments of the present disclosure, one end of the mechanical spring 6 is hinged with the connector 4. In some other embodiments of the present disclosure, the end part of the mechanical spring 6 is also hinged with the lower connecting arm 3.

In the embodiments provided by the present disclosure, one end of the mechanical spring 6 is hinged to the connector 4, the other end is hinged with the threaded sliding block 7, the threaded sliding block 7 is in threaded connected with the threaded rod 8, and the mechanical spring 6, the threaded sliding block 7 and the threaded rod 8 are all installed on the base 1. As shown in FIG. 2 and FIG. 3, the mechanical spring 6 is in a stretched state. The threaded rod 8 can be rotated with a hexagon wrench, so that the threaded sliding block 7 moves up and down on the threaded rod 8, and an angle between the mechanical spring 6 and the upper connecting arm 2 or between the mechanical spring 6 and the lower connecting arm 3 is changed, so as to realize free stop at different bearing heights. The sliding range of the threaded siding block 7 and an installation position of the corresponding threaded rod 8 can be arranged to realize the free stop of the display within a required load-bearing range.

Therefore, in order to realize the free stop of the display within the required load-bearing range, the display support provided by some embodiments of the present disclosure simultaneously satisfies the following balance conditions:

First balance condition: maintaining the connector 4 at any height within a preset height range, driving the threaded siding block 7 to move by driving the threaded rod 8 to rotate, and ensuring that a gravitational torque M1 is equal to an elastic torque M2, so as to adapt to the display of any weight within a preset weight range.

Second balance condition: according to the first balance condition, maintaining the position of the threaded sliding block 7 corresponding to the weight of the display on the threaded rod 8, and when the height of the connector 4 is arbitrarily changed within the preset height range, ensuring that the gravitational torque M1 is equal to the elastic torque M2, so that the connector 4 is stopped at different heights relative to the base 1.

For the first balance condition, as shown in FIG. 4, the connector 4 is maintained at any height within the preset height range, that is, an angle a between the upper connecting arm 2 or the lower connecting arm 3 and the horizontal plane is unchanged. At this time, in order to adapt to the display of any weight within the preset weight range, the threaded rod 8 can be rotated with the hexagon wrench, so that the threaded sliding block 7 moves up and down on a special screw, that is, the threaded sliding block 7 moves on the threaded rod 8 in a length direction of the threaded rod 8, so as to change a position of the threaded sliding block 7 on the threaded rod 8, that is, to change an angle b between the mechanical spring 6 and the upper connecting arm 2 or the lower connecting arm 3.

The gravitational torque M1=GL*cos(a), the elastic torque M2=F*L*sin(b), and the gravitational torque is the same as the elastic torque. L represents the length of the upper connecting arm 2 or the lower connecting arm 3, G represents the gravity, and F represents an elastic force, then G=F sin(b)/cos(a). The angle a is constant, the elastic force F is also constant, therefore, when b is reduced, that is, the threaded sliding block 7 slides down, G is reduced, that is, the weight of the display is reduced. Therefore, for the display within the preset weight range, the weight is reduced. When b is smaller, it indicates that the position of the threaded sliding block 7 on the threaded rod 8 is lower. As shown in FIG. 4, a point E is the highest point of the threaded sliding block 7, and at this time, the angle b between the mechanical spring 6 and the upper connecting arm 2 or the lower connecting arm 3 is the maximum; and a point F is the lowest point of the threaded sliding block 7, and at this time, the angle b between the mechanical spring 6 and the upper connecting arm 2 or between the mechanical spring 6 and the lower connecting arm 3 is the minimum.

For the second balance condition, the weight of the display is constant, the position of the threaded sliding block 7 in the threaded rod 8 is constant, when the position of the display is adjusted in a vertical direction, that is, the angle a can be arbitrarily changed within a preset angle range, and during this process, the gravitational torque M1 is equal to the elastic torque M2 as well.

It is assumed that, a preset range of the angle a is (33°, −33°), when the angle a changes from 33° into −33°, since the mechanical spring 6 is stretched all the time, the elastic force F is constantly increasing, accordingly, to make M1=M2, the angle b between the mechanical spring 6 and the upper connecting arm 2 or the lower connecting arm 3 needs to be continuously reduced, so as to ensure that the torque M2 provided by the elastic force is basically unchanged.

Therefore, according to the preset weight range and the preset height range/the preset angle range, a corresponding configuration position of the threaded rod 8 or a movement trajectory of the threaded sliding block 7 is obtained by calculation.

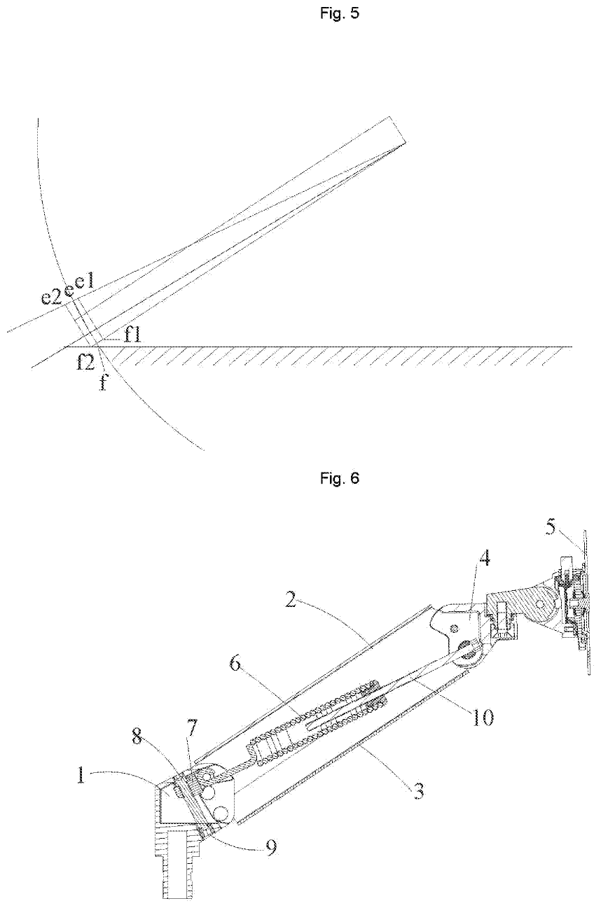

As shown in FIG. 5, based on the first balance condition and the second balance condition, a preliminary movement trajectory of the threaded sliding block 7 is determined, that is, with a connecting point G of the mechanical spring 6 on the connector 4 as a center of circle, and with the length L1 of the mechanical spring 6 when the connector 4 is at a preset maximum height as a radius, a circle C is drawn. When the included angle b between the mechanical spring 6 and the upper connecting arm 2 or the lower connecting arm 3 is at a maximum value and a minimum value, straight lines La and Lb passing through the point G are respectively formed, intersection points of the circle C With the straight lines La and Lb form a point e and a point f respectively, a line segment ef is translated upwards and downwards for 5 mm in a direction perpendicular to the line segment ef, respectively, so as to obtain line segments e₁f₁ and e₂f₂, and a movement trajectory range of the threaded sliding block 7 is formed, that is, a quadrilateral e₁f₁f₂e₂.

When the connector 4 is maintained at any horizontal height within the preset height range, according to the maximum value and the minimum value of the preset weight range of the display, the maximum value and the minimum value of the included angle b between the mechanical spring 6 and the upper connecting arm 2 or the lower connecting arm 3 are obtained, that is, according to the maximum value of the preset weight range of the display, the maximum value of the included angle b between the mechanical spring 6 and the upper connecting arm 2 or the lower connecting arm 3 is obtained; and according to the minimum value of the preset weight range of the display, the minimum value of the included angle b between the mechanical spring 6 and the upper connecting arm 2 or the lower connecting arm 3 is obtained.

That is to say, the movement trajectory of the threaded sliding block 7 is a line segment e₀f₀ formed by connecting a point e₀ with a point fa in the quadrilateral e₁f₁f₂e₂, and the threaded rod 8 is set to be consistent with the movement trajectory of the threaded sliding block 7. As shown in FIG. 4, in some embodiments of the present disclosure, the included angle a between the threaded rod 8 and a horizontal direction away from the connector 4 is 0-80°.

In order to further determine the movement trajectory of the threaded sliding block 7, in some embodiments, the movement trajectory can be determined by an elastic coefficient of the mechanical spring 6. For the same spring, the stiffness K (the elastic coefficient) of the spring needs to be a certain value or have little difference in size. Based on K=increment ΔF of a spring force/a deformation amount ΔX of the mechanical spring 6, which is a certain value or has little difference in size, the movement trajectory of the threaded sliding block 7 is verified by the following formula, and the elastic coefficient of the mechanical spring 6 is determined.

$$K = ( \frac{G cos ( a 1 )}{sin ( b 1 )} - \frac{G cos ( a 2 )}{sin ( b 2 )} ) / ( L 1 - L {1}^{′} )$$

in the formula, G represents the weight of the display;

a1 and a2 respectively represent the angles between the upper connecting arm 2 or the lower connecting arm 3 and the horizontal plane when the connector 4 is at two arbitrary heights within the preset height range;

b1 and b2 respectively represent the included angles between the mechanical spring 6 corresponding to a1, a2 and the upper connecting arm 2 or the lower connecting arm 3; and

L1 and L1′ respectively represent the lengths of the mechanical spring 6 corresponding to a1 and a2.

By the above formula, a plurality of K values is obtained, the elastic coefficient K of the mechanical spring 6 is selected from Kmin−Kmax, wherein Kmax−Kmin≤15; and it can be verified whether any point of the line segment e₀f₀ satisfies the requirements, if not, the position is adjusted slightly, and the verification is performed again. Actually, the obtained point may float up and down, and the final drawn straight line is used as the movement trajectory of the threaded sliding block 7.

When the connector 4 is at the preset maximum height, the length L1 of the mechanical spring 6 is set to be L-x, wherein L represents a distance from a connecting point between the mechanical spring 6 and the connector 4 or the lower connecting arm 3 to a hinge point between the lower connecting arm 3 and the base 1, and x is −10-30 mm. In order to satisfy the second balance condition, when the preset angle/height range changes, theoretically, and when the angle a is the maximum, if the length L1 of the mechanical spring 6 is greater than or equal to L, it can be ensured that the angle b is constantly decreasing while rotating downwards. But in fact, the torque provided by the gravity is M1=GL*cos(a), the gravity G is unchanged, in a starting stage, when the angle a changes from 33° to 0°, the gravitational torque M1 increases, but the change value is not large, especially in a second hag of segment, due to a greater change in the elastic force, the change in the gravitational torque can be ignored, that is, it is regarded as a constant value. Therefore, the length L1 of the mechanical spring 6 is set to be L-x, and x is −10-30 mm.

In some embodiments, taking the display bearing 2-9 kg as an example, the angle a is set to change from 33° to −33°, and G is calculated as 30-100 N including the own weight of the display, assuming that the elastic force F=700 N, it can be obtained that the minimum value bmin is about 2, and the maximum value bmax is about 7.5°; and L=240 mm, x=5 mm, L1=235 mm.

As shown in FIG. 6, the display support includes an adjusting rod 10, one end of the adjusting rod 10 is hinged with connector 4 or the lower connecting arm 3, the other end of the adjusting rod 10 is in threaded connection with one end of the mechanical spring 6, and when an end part of the adjusting rod 10 is operated to drive the adjusting rod 10 to rotate, the mechanical spring 6 is driven to expand and contract, so as to adjust an elastic force of the mechanical spring 6 and adapt to the display within the preset weight range.

If only the mechanical spring 6 is provided, when the display support is installed, the deformation amount of the mechanical spring 6 has been determined, then a tension of the mechanical spring 6 has been fixed in use, and thus is difficult to adjust; after the adjusting rod 10 is installed, the tension of the mechanical spring 6 is adjusted, and specifically, the mechanical spring 6 can be controlled to stretch by rotating the adjusting rod 10, so as to change the size of the elastic force; and by adjusting the size of the elastic force, the weight range of the display is set more flexibly. For example, if the elastic force is 700 N, the weight range of the display is 2-9 kg, and if the elastic force is adjusted to 800 N, the weight range of the display can reach 3-11 kg.

By using the display support having the freely adjustable height in the embodiments of the present disclosure, free stop of height adjustment is realized by using the mechanical spring 6, and thus is better than an air spring support. Since the display support is provided with the parallelogram structure, the height of the display installed on the connector 4 is adjusted by adjusting the included angle between the upper connecting arm 2 or the lower connecting arm 3 and the horizontal plane. In addition, since the display support further includes the mechanical spring 6, the threaded sliding block 7 and the threaded rod 8, and can be rotated by operating the threaded rod 8, the threaded sliding block 7 is driven to move along the threaded rod 8, and the mechanical spring 6 is hinged to the threaded rod 8, so that when the threaded sliding block 7 moves along the threaded rod 8, the length of the mechanical spring 6 changes, and the elastic force generated by the mechanical spring 6 also changes. The display fixed to the connector 4 can generate a clockwise gravitational torque on the connector 4, and the mechanical spring 6 can generate a counterclockwise elastic torque on the connector 4. Therefore, by the weight of the display, the size of the elastic force is determined, so as to determine the deformation amount of the mechanical spring 6 and the position of the threaded sliding block 7 on the threaded rod 8, such that the gravitational torque and the elastic torque are the same. As a result, the two torques received by the display can cancel each other, and then the display is fixed at the position after the position is adjusted.

As shown in FIG. 7 to FIG. 12b, another aspect of the embodiments of the present disclosure provides a display support having a freely adjustable height, wherein the display support includes a base 1 and a connector 4, the base 1 is installed on a supporting arm, and a connecting plate 25 is arranged on the connector 4, the connecting plate 25 is configured for installing the display.

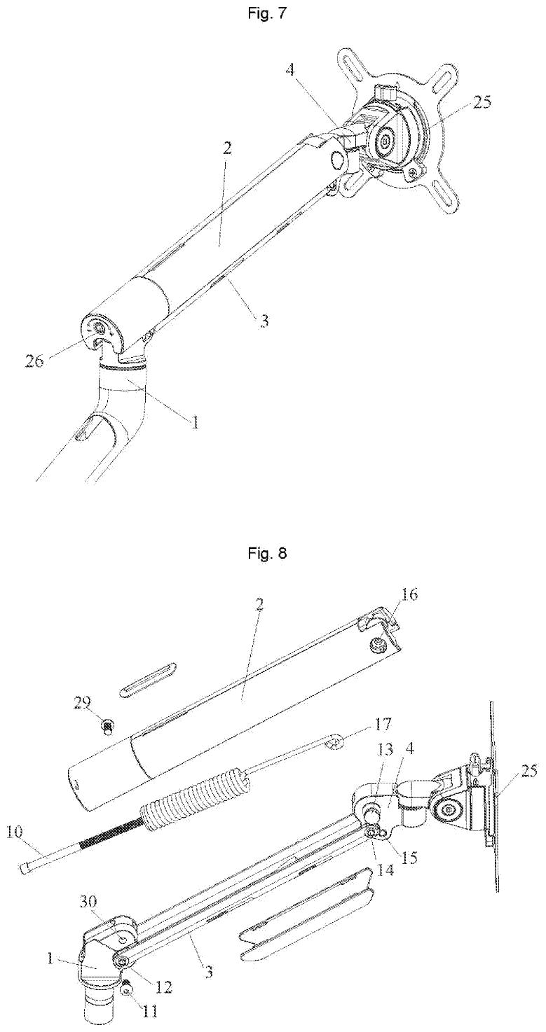

As shown in FIG. 8, an upper connecting arm 2 and a lower connecting arm 3, which are parallel to each other, are arranged between the base 1 and the connector 4, and end parts of the upper connecting arm 2 and the lower connecting arm 3 are respectively hinged with the base 1 and the connector 4.

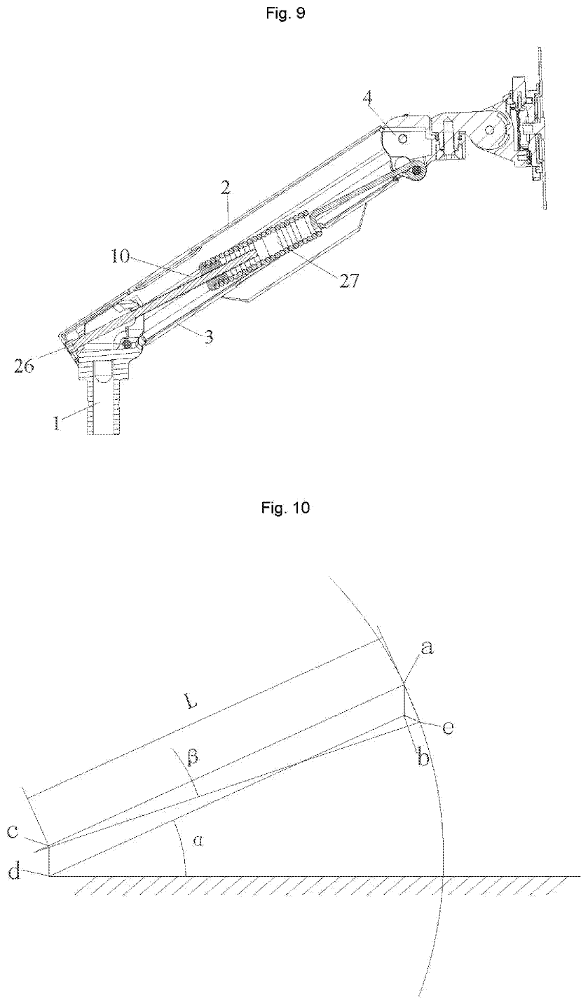

FIG. 10 is a simplified diagram of the display support shown in FIG. 9. As shown in FIG. 10, the end parts of the upper connecting arm 2 and the lower connecting arm 3 are respectively hinged with the base 1 and the connector 4, so as to form four hinge points a, b, c and d, the hinge point a is formed between the upper connecting arm 2 and the connector 4, the hinge point b is formed between the lower connecting arm 3 and the connector 4, the hinge point d is formed between the lower connecting arm 3 and the base 1, the hinge point c is formed between the upper connecting arm 2 and the base 1, the connector 4 is located between the hinge point a and the hinge point b, the base 1 is located between the hinge point c and the hinge point d, a parallelogram structure is formed among the upper connecting arm 2, the lower connecting arm 3, the base 1, the connector 4 and the four hinge points a, b, c and d, and the four hinge points a, b, c and d are four vertexes of the parallelogram structure.

Both the upper connecting arm 2 and the lower connecting arm 3 are hinged with the base 1 and the connector 4 by connecting shafts and shaft holes matching the connecting shafts. As shown in FIG. 8, the upper connecting arm 2 is hinged with the base 1 and the connector 4 by shaft holes 30,16 and connecting shafts 29, 13 and 11 matching the same; and the lower connecting arm 3 is respectively hinged with the base 1 and the connector 4 by connecting shafts 12, 14 and corresponding shaft holes. Therefore, the connector 4 is rotated around the base 1, so as to change the position of the connector 4.

As shown in FIG. 7 to FIG. 10, in some embodiments, the display support further includes an elastic force balance mechanism, the elastic force balance mechanism includes an elastic member 27 and an adjusting rod 10, an end of the adjusting rod 10 is hinged with the upper connecting arm 2, the other end of the adjusting rod 10 is in threaded connection with an end of the elastic member 27, and the other end of the elastic member 27 is hinged with the connector 4. As shown in FIG. 10, the elastic member 27 and the connector 4 form a connecting point e.

Based on the parallelogram structure and the elastic force balance mechanism, the elastic force of the elastic force balance mechanism is adjusted according to the weight of a display to be installed, so that when the connector 4 is moved upwards or downwards, the connector 4 can be stopped at different heights relative to the base 1. When the end part of the adjusting rod 10 is operated to drive the adjusting rod 10 to rotate, the elastic member 27 is driven to expand and contract, so that the elastic force of the elastic member 27 cooperates with the weight of the display on the connector 4.

Specifically, the display fixed to the connector 4 can generate a clockwise gravitational torque on the connector 4, and the elastic force balance mechanism can generate a counterclockwise elastic torque on the connector 4. Therefore, by the weight of the display, the size of the elastic force of the elastic force balance mechanism is determined, such that the gravitational torque and the elastic torque are the same. As a result, the two torques received by the display can cancel each other, and then the display is fixed at the position after the position is adjusted.

Therefore, when the product of the embodiments of the present disclosure is used, the elastic force of the elastic member 27 can be adjusted to adapt to heavy objects of different weights, such as a display. For example, when the installed heavy object is 1 kg, a tool such as a wrench is used to rotate the adjusting rod 10, so that the elastic member 27 is stretched to produce a certain deformation amount, until the elastic force of the elastic member 27 and the heavy object reach a balance. After reaching the balance, the display can be moved upwards or downwards to any position without falling down or rising up, that is, the display can be stopped at any height. When the heavy object to be installed is 10 kg, similarly, it is also necessary to rotate the adjusting rod 10 to stretch the elastic member 27, so as to produce a certain deformation amount, so that the elastic force of the elastic member 27 and the heavy object can reach a new balance.

In some embodiments, as shown in FIG. 7 and FIG. 10, the end part of the upper connecting arm 2 is provided with an operating hole 26, the end part of the adjusting rod 10 is installed in the operating hole 26, and the end part of the adjusting rod 10 is operated by the operating hole 26.

As shown in FIG. 8, in some embodiments, the elastic member 27 can be installed on a mounting shaft 15 of the connector 4 by a mounting ring 17 at the end part thereof. For the specific position of the end part of the elastic member 27 on the connector 4 and the upper connecting arm 2, in the embodiment as shown in FIG. 10, the hinge point a and the hinge point b are located on the same vertical plane, the hinge point c and the hinge point d are located on the same plane, the connecting point e formed by the elastic member 27 and the connector 4 is located on an outer side of the vertical plane where the hinge point a and the hinge point b are located, and the connecting point between the adjusting rod 10 and the upper connecting arm 2 is located on an outer side of the vertical plane where the hinge point c and the hinge point d are located. The connecting point e formed by the elastic member 27 and the connector 4 is located obliquely below the hinge point b between the lower connecting arm 3 and the connector 4. In some other embodiments, the connecting point e formed by the elastic member 27 and the connector 4 can be located at any other position of the connector 4, for example, located on the hinge point b between the lower connecting arm 3 and the connector 4, or diagonally above the hinge point b, etc.

As shown in FIG. 10, it is set that the length of the upper connecting arm 2 is L, the included angle between the elastic force balance mechanism and the upper connecting arm 2 is P, the included angle between the upper connecting arm 2 and the horizontal plane is a, G represents the gravity, F represents the elastic force, and a circular arc represents a movement trajectory of the point a. Because the gravity is downward, for the heavy object, the direction of the torque provided by the gravity of the heavy object itself is clockwise, and the direction of the torque provided by the elastic member 27 for the heavy object is counterclockwise, therefore the two directions are opposite. Moreover, the torque provided by the gravity of the heavy object itself is M1=GL*cos(a), and the torque of tension provided by the elastic member 27 is M2=F*L*sin(p), therefore, when M1=M2, the clockwise and counterclockwise torques are equal in size and cancel each other, that is, the heavy object can be stopped at any height.

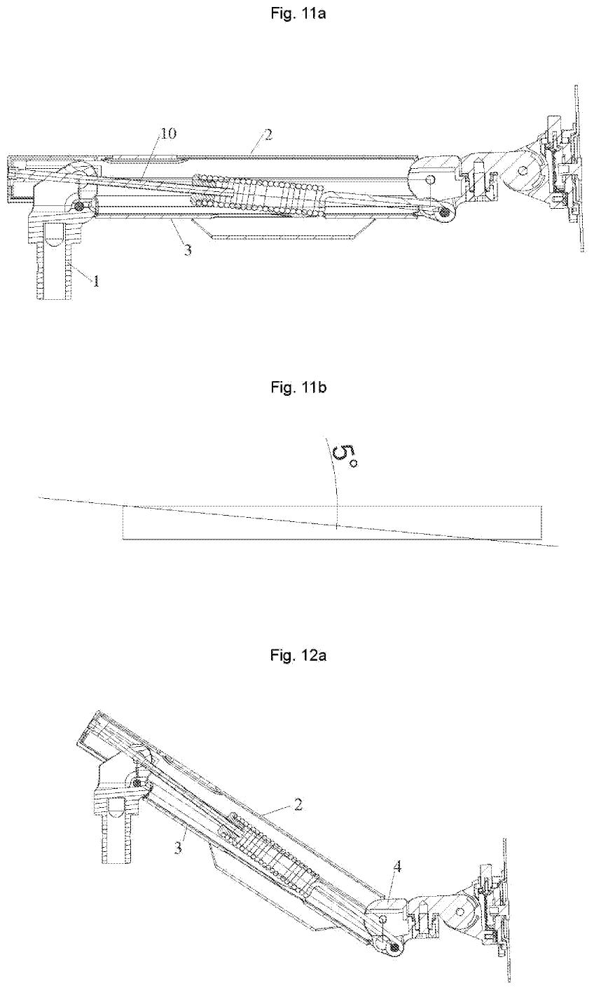

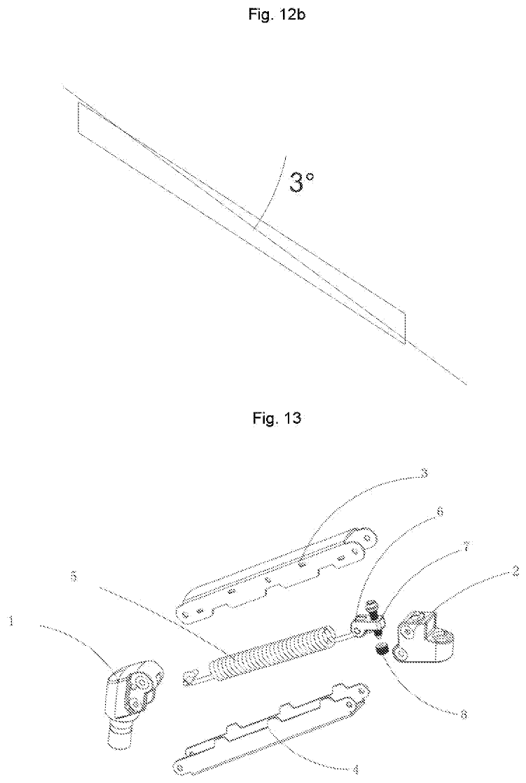

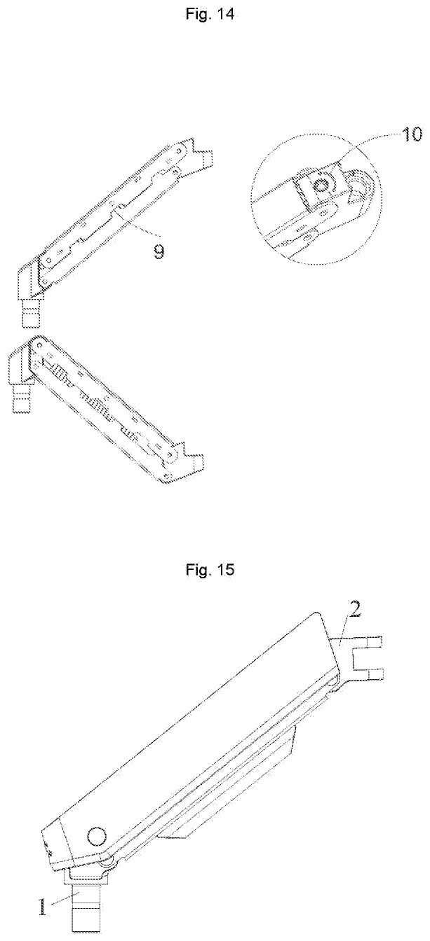

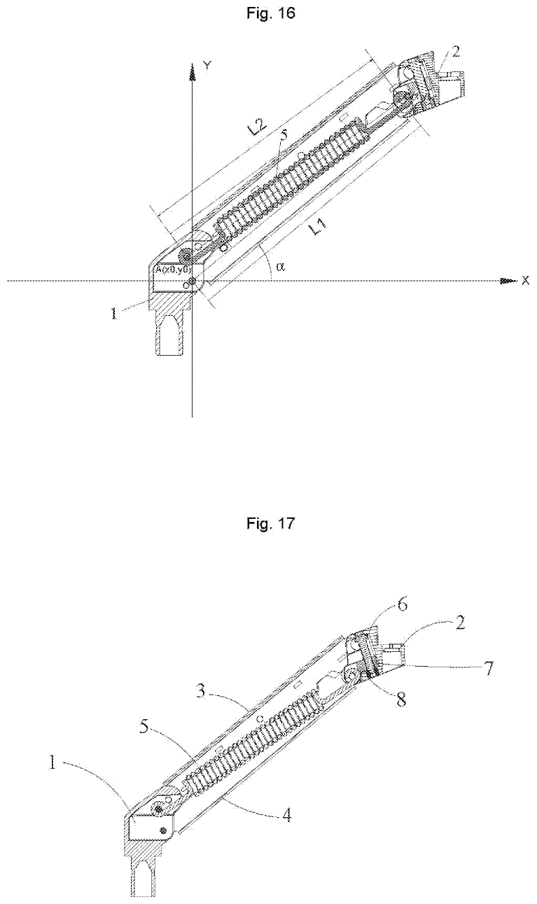

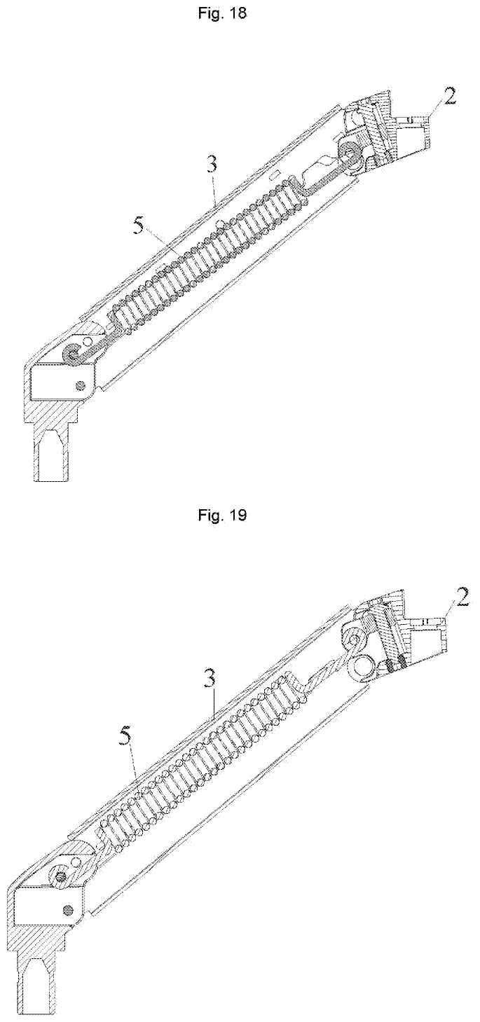

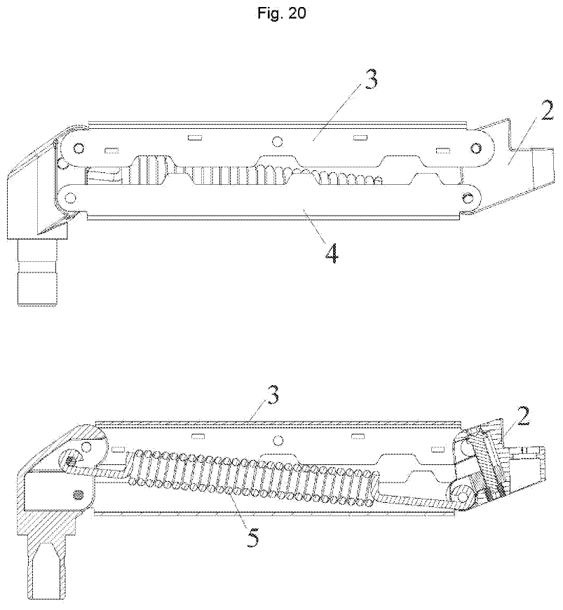

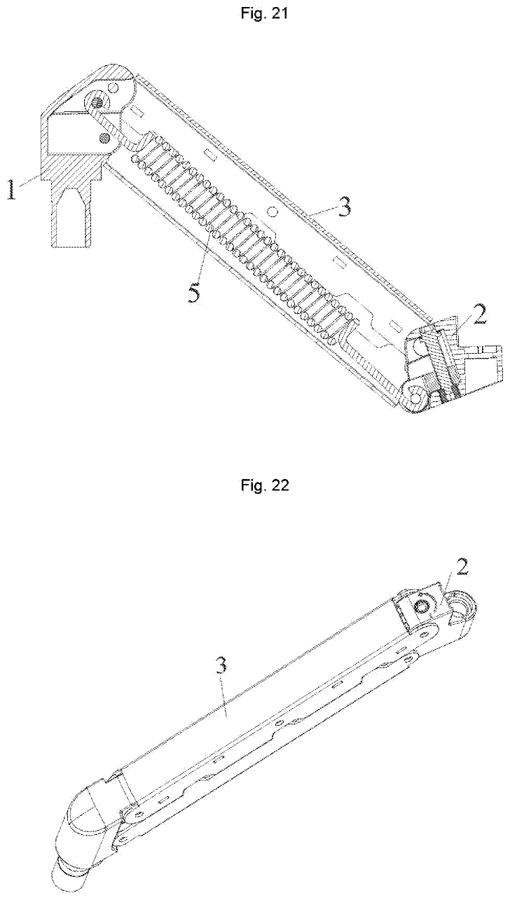

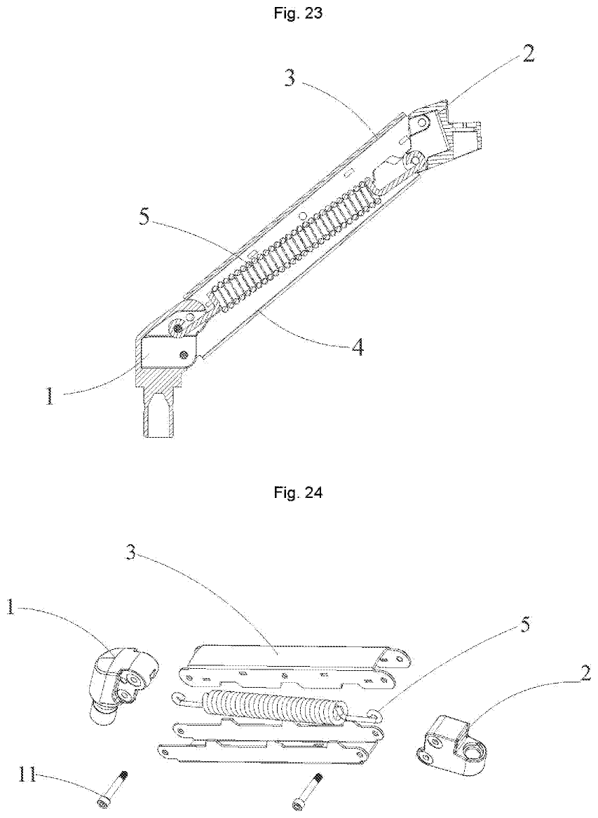

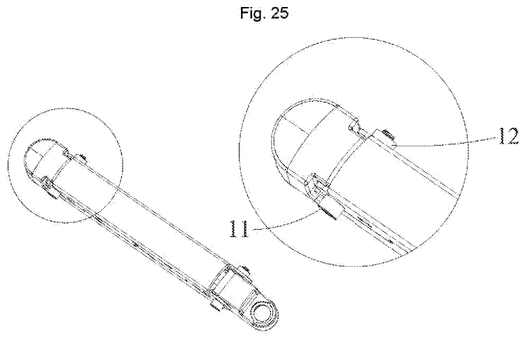

Based on the configuration position of the elastic force balance mechanism relative to the parallelogram structure in the embodiments of the present disclosure, as shown in FIG. 11a to FIG. 12b, after the display and the elastic force balance mechanism are adjusted to reach a balance, the display can be rotated up and down arbitrarily and stopped. During the upward and downward rotation process of the display, the elastic member 27 will be continuously stretched, the elastic force will increase, and the included angle β between the elastic force balance mechanism and the upper connecting arm 2 will decrease, change from 6° to 5°, and change to 3°, so that the torque remains unchanged. In this way, during the upward and downward rotation process, the torque provided by the elastic member 27 is the same at any position, and free stop at any position is realized.

By using the display support having the freely adjustable height in the embodiments of the present disclosure, and on the basis of the configuration position of the elastic force balance mechanism relative to the parallelogram structure, free stop during height adjustment can be realized. Moreover, the display support has few parts, a simple structure, a lower cost and a beautiful appearance.

On the market, supports with adjustable load-bearings and freely stopped heights are mainly realized by air spring structures or mechanical spring structures. An air spring has the disadvantages of high cost, short life, hidden danger of oil leakage, stable performance and non-environmental protection (due to disposal difficulty after being scrapped), but the air spring has a stable force, thereby having better experience in different load-bearings and free stop in height. Air spring display supports still dominate at present.

A mechanical spring has the advantages of low cost, long lie, stable performance, safety and environmental protection, etc. However, a mechanical spring display support known to inventors relies too much on a friction force to achieve balance in terms of different load-bearings and free stop in height, such that the experience is worse. Furthermore, the range of different load-bearings is not large. Therefore, supports of the mechanical spring structures are scarcely applied.

To meet the balance at different load-bearing heights, the support requires an adjustment mechanism. Different load-bearing requirements are satisfied by the adjustment mechanism. The adjustment mechanism is mainly arranged on a front end of the support on the market at present, which limits the appearance of the product and proposes requirements for an internal space.

In order that the technical content of the present disclosure can be described more clearly, a further description will be given below in conjunction with specific embodiments.

A balance device for realizing adjustable load-bearing of a support in the present disclosure includes a base, a mechanical spring and a connector for installing a display, an upper arm plate and a lower arm plate are arranged between the base and the connector, a quadrilateral structure is formed among a hinge point between the upper arm plate and the connector, the connector, a hinge point between the lower arm plate and the connector, the lower arm plate, a hinge point between the lower arm plate and the base, the base, a hinge point between the upper arm plate and the base, and the upper arm plate, and an end of the mechanical spring is hinged with the base.

In an embodiment of the present disclosure, the device further includes a threaded sliding block and a threaded rod, the other end of the mechanical spring is hinged with the threaded sliding block, the threaded sliding block sleeves on the threaded rod, the threaded rod is installed on the connector, and when an end part of the threaded rod is operated to drive the threaded rod to rotate, the threaded sliding block moves along the threaded rod.

In an embodiment of the present disclosure, a position of the threaded sliding block on the threaded rod is adjustable, according to the weight of the display connected with the connector, so that when the connector is moved upwards or downwards, the connector is adjusted to stop at different heights relative to the base.

In an embodiment of the present disclosure, the lower arm plate is provided with a convex block, and the upper arm plate is provided with a groove corresponding to the convex block.

In an embodiment of the present disclosure, the device further includes threads and a locking screw, the other end of the mechanical spring is hinged with the connector or the lower arm plate, the locking screw is matched with the threads, the threads are arranged in hinge holes of the upper arm plate or the lower arm plate and the base or the connector, the hinge manner between the upper arm plate and the base, between the upper arm plate and the connector, between the lower arm plate and the base, and between the lower arm plate and the connector is a locking screw connection, or a riveting connection.

In some embodiments of the present disclosure, a balance mechanism is provided, in which an adjustment mechanism on the support is rear-mounted and a mechanical spring is used to realize free stop in height. Some embodiments of the present disclosure include two hardware structures.

1. The first structure is as follows:

The display support includes a base and a connector for installing a display, an upper connecting arm and a lower connecting arm, which are parallel to each other, are arranged between the base and the connector, and a quadrilateral structure is formed among a hinge point between the upper connecting arm and the connector, the connector, a hinge point between the lower connecting arm and the connector, the lower connecting arm, a hinge point between the lower connecting arm and the base, the base, a hinge point between the upper connecting arm and the base, and the upper connecting arm.

The display support further includes a mechanical spring, an end of the mechanical spring is hinged with the base, the other end of the mechanical spring is hinged with a threaded sliding block, the threaded sliding block sleeves on a threaded rod, the threaded rod is arranged on the connector, so that when an end part of the threaded rod is operated to drive the threaded rod to rotate, the threaded sliding block is able to move along the threaded rod, and the position of the threaded sliding block on the threaded rod is adjusted according to the weight of the display on the connector, so that when the connector is moved upwards or downwards, the connector is freely stopped at different heights relative to the base.

In this connection manner of the mechanical spring, one end of the spring is hinged to the base, and the other end is hinged to the threaded sliding block, so as to be installed on the connector together. Such a arrangement has lower requirements on the shape of the base and the size of an internal space (because a force value does not need to be adjusted on the base, but is adjusted on the connector). It can be applied to supports that are different from conventional shapes.

The balance mechanism of this structure uses a mechanical spring, which has the advantages of low cost, high life, stable performance, safety and environmental protection, etc. By using the balance principle and structural mechanics analysis, combined with force value characteristics of the mechanical spring, spring parameters, a reasonable installation position and a movement trajectory of the threaded sliding block are designed, so as to meet an effect of free stop at different load-bearing heights, and to solve the problem that mechanical spring supports rely too much on friction force, thus affecting an user experience. The air spring known to inventors is also replaced, thereby greatly reducing the cost.

In some embodiments, the lower arm plate is provided with a convex block, and the upper arm plate is provided with a corresponding groove, so that positions of the highest point and the lowest point are limited.

The connector is provided with a corresponding rotation identifier for facilitating the operation of a user.

The principle of free balance hovering technology of the mechanical spring in the first structural solution is as follows:

The free balance hovering technology is a convenient way for people to adjust the height of the display without using tools. The user only needs to move the display to a desired height, and then the display can be stopped freely, which meets the requirement of the user to face the display in a comfortable posture. At present, the most widely used elastic elements in this technology on the market are air springs, which have the disadvantages of high cost, short life, hidden danger of oil leakage, and non-environmental protection (due to disposal difficulty after being scrapped). The uniqueness of this technology is that the conventional air spring elastic element is replaced with a mechanical spring, and the adjustment mechanism is arranged on a rear end (at the connector). By applying the balance principle and structural mechanics analysis, combined with the force value characteristics of the mechanical spring, an objective function equation formula is established. By using computer optimization analysis, and synthesizing structural features and application characteristics of the product, a structural size of the connecting arm, a combination of related spring parameters and the size of a spring installation position are calculated, so as to achieve an optimal effect of realizing constant force load-bearing within a reasonable weight range and a reasonable height adjustment range. The adjustment is simple and convenient, the balance experience effect is as good as that of an air spring structure, and it also has the advantages of low cost, simpleness and reliability, long life, safety and environmental protection, etc. Since the adjustment mechanism is arranged on the rear end, there are more choices for the appearance molding of the overall product.

A two-dimensional coordinate system is established by taking a hinge point between the base and the lower arm as a coordinate origin O.

A point B is the hinge point between the lower arm plate and the connector, and OB represents the length L1 of the lower arm plate. A point A (x0, y0) is the hinge point of one end of the spring on the base, a point C (x, y) is the other end of the spring, which is hinged with the threaded sliding block and is fixed to the connector together, and AC represents the length L2 of the spring after being stretched. An angle a is an included angle between the lower arm plate and an X axis of a horizontal plane, and an angle b is an included angle between the spring AC and the lower arm plate OB.

Since a panel on which the display is installed is installed on the connector, to realize the free stop of the display in height, it is also necessary to realize the free stop of the connector in height. The hinge point B between the connector and the lower arm plate is taken as an object for analysis and research.

In order to meet the requirements of different load-bearing and free stop in height, the balance system needs to meet the following two balances at the same time.

Balance 1: at an initial angle a0, an adjusting screw is rotated to control the threaded sliding block to move up and down, so as to change the position of one and of the mechanical spring, and to change the size of the included angle b between the mechanical spring and the lower arm plate to meet the display of different load-bearings.

In order to achieve the balance of the display in height, that is, a torque M1 provided by gravity must be equal to a torque M2 of tension provided by the spring, that is, mg×L1× cos (a0)=F×L2×sin (b) (m represents the weight m of the display, F represents a tensile force of the spring, a0 represents an initial position angle of the lower arm, and b represents the included angle between the spring AC and the lower arm plate OB)

$$m = \frac{F \times L 2 \times sin ( b )}{g \times L 1 \times cos ( a 0 )} is obtained from the above formula ;$$

and

when the adjusting screw is rotated to control the threaded sliding block to move up and down, the change in the length AC of the spring is relatively small and can be regarded as unchanged, so the elastic force F also remains unchanged. Therefore, when the threaded sliding block moves upwards, the included angle b between the mechanical spring and the lower arm plate is reduced, and it is obtained from the formula that the set weight m of the display is reduced. When the threaded sliding block moves downwards, the included angle b between the mechanical spring and the lower arm plate is increased, and it can be obtained from the formula that the set eight m of the display is increased. Thereby, a balance of displays of different weights is realized.

The user only needs to perform rotation adjustment according to the rotation identifier on the connector, and then the user is able to control the size of an elastic force torque that is used for balancing the weight of the display.

Balance 2: when the weight Is constant, and when the position of the display is adjusted up and down, that Is, when the angle a changes, it is also necessary to ensure the balance.

According to the theorem of kinetic energy, the work done by a force on an object in a process is equal to the change in the kinetic energy of the object in this process. That is,

½mv₂²−½mv₁²=W₁₂.

External forces that the whole mechanism is subjected to during a movement process are only the elastic force and the gravity. To realize free stop at any point in height within the movement range, that is, at any angle a, after an angle Δa is rotated, the difference in speeds before and after the rotation is v2=v1=0, that is, the change in the kinetic energy is 0. Therefore, at any angle a, in the process of rotating downwards for the angle Δa, the sum of the work done by the gravity and the work done by the elastic force is 0 In this process, the gravity does positive work, and the elastic force does negative work.

That is, W_{gravity}−W_{elastic force}=0

The work done by the gravity in this process is: W_{gravity}=mg×L1 (sin a−sin(a+Δa)

The work done by the elastic force is: W_{elastic force}=∫ₓ₁^{x2}kxdx=½k(x₂²−x₁²)

The weight of the display is m, a stiffness coefficient of the spring is k, the initial position angle is a0, the rotation angle a corresponds to a stretching amount x1 of the spring, a rotation angle a+Δa corresponds to a stretching amount x2 of the spring, and the weight m of the display corresponds to an initial stretching amount x0 of the spring.

According to the above requirements, an objective function equation formula is established. By using computer optimization analysis and integrating the characteristics of the spring, a combination of related spring parameters and a spring installation position are calculated.

2. The second structure is as follows:

According to the formula of the first structure described above, installation positions of both ends of the mechanical spring for realizing the free stop in height of a certain display with a weight m are calculated, and then the upper arm plate and the lower arm plate are locked to increase the friction force, so as to realize the free stop in different load-bearing heights. In this solution, adjustment mechanisms such as the threaded sliding block and adjusting screw are canceled, therefore the cost is reduced, and the free stop in the height of the display of different load-bearings is realized without performing adjustment. However, due to the participation of a relatively large friction force, the use experience effect is worse

The structure of this solution is as follows:

The support includes a base and a connector for installing a display, an upper connecting arm and a lower connecting arm, which are parallel to each other, are arranged between the base and the connector, and a quadrilateral structure is formed among a hinge point between the upper connecting arm and the connector, the connector, a hinge point between the lower connecting arm and the connector, the lower connecting arm, a hinge point between the lower connecting arm and the base, the base, a hinge point between the upper connecting arm and the base, and the upper connecting arm.

Threads are arranged in hinge holes of the upper arm plate with the base, the upper arm plate with the connector, the lower arm plate with the connector, and the lower arm plate with the base. The hinge manner of the upper arm plate with the base and the connector, and the hinge manner of the lower arm plate with the base and the connector are screw threaded connections, or riveting (which requires a greater riveting force).

One end of the mechanical spring is hinged with the base, and the other end is hinged with the connector or the lower arm.

According to balance 2: when the weight Is constant, and when the position of the display Is adjusted up and down, that Is, when the angle a changes, it is also necessary to ensure the balance.

According to the theorem of kinetic energy, the work done by a force on an object in a process is equal to the change in the kinetic energy of the object in this process That is,

½mv₂²−½mv₁²=W₁₂. External forces applied during this process include an elastic force, gravity and a friction force.

After an angle Δa is rotated, the difference in speeds before and after the rotation is v2=v1=0, that is, the change in the kinetic energy is 0. Therefore, at any angle a, in the process of rotating downwards for the angle Δa, the sum of the work done by the gravity, the work done by the elastic force and the work done by the friction force is 0. In this process, the gravity does positive work, the elastic force does negative work, and the friction force can either do positive work or negative work, or the work done by the friction force is 0.

When the gravity is greater than the elastic force, the friction force does negative work, that is, W_{gravity}−W_{elastic force}−W_{friction force}=0.

When the gravity is less than the elastic force, the friction force does positive work, that is, W_{gravity}−W_{elastic force}+W_{friction force}=0.

When the gravity is equal to the elastic force, the friction force can be 0.

According to the above formula, by adjusting the connection positions on both ends of the mechanical spring and integrating the feature properties of the mechanical spring, the free stop in the height of the display of a certain weight is realized without the friction force, for example, a display of 5 kg. Then, by locking hinge screws of the upper arm plate with the base and the connector, or riveting rivets, the friction force is increased to realize the free stop in the height of 2-9 kg. The use experience is worse due to the participation of the friction force. However, since the parts of the adjustment mechanism such as the threaded sliding block, the adjusting screw and a lock nut are canceled, the cost is lower, and it also has the advantages of being free of restriction by appearance, unnecessary to adjust the force value, convenient to use, etc.

By using the balance device for realizing adjustable load-bearing of the support provided by the present disclosure, a mechanical spring type support is provided, in which the adjustment mechanism is arranged on the rear end, and which is convenient to adjust, can realize free stop at different load-bearing heights, and has better experience. The embodiments break through the limitation of conventional appearance, so that the shape is more novel. Moreover, an air spring is replaced with the mechanical spring, which is lower in cost, and is safer, more stable and more reliable than an air spring support.

In this specification, the present disclosure has been described with reference to specific embodiments thereof. However, it is apparent that various modifications and changes can still be made without departing from the spirit and scope of the present disclosure. Accordingly, the specification and drawings should be regarded to be illustrative rather than restrictive.

It should be noted that, in this document, relational terms such as first and second are only used for distinguishing one entity or operation from another entity or operation, and do not necessarily require or imply the presence of any such an actual relationship or sequence between these entities or operations. Moreover, the terms “comprising”, “including” or any other variations thereof are intended to cover non-exclusive inclusions, so that a process, a method, an article or a device including a series of elements not only include those elements, but also include other elements that are not explicitly listed or other elements inherent to such process, method, article or device. In the absence of further limitation, an element defined by the statement “including a . . . ” does not exclude the presence of additional identical elements in the process, method, article or device that includes the element.

The above descriptions are only some embodiments of the present disclosure, and are not intended to limit the present disclosure. Any modifications, equivalent replacements, improvements and the like, made within the spirit and principles of the present disclosure, shall all be included in the protection scope of the present disclosure.

What is claimed is:

1. A display support having a freely adjustable height, wherein the display support comprises:
a base;
a connector for installing a display;
an upper connecting arm and a lower connecting arm, which are parallel to each other, being arranged between the base and the connector, and
a quadrilateral structure is formed among a hinge point between the upper connecting arm and the connector, the connector, a hinge point between the lower connecting arm and the connector, the lower connecting arm, a hinge point between the lower connecting arm and the base, the base, a hinge point between the upper connecting arm and the base, and the upper connecting arm; and
the display support further comprises a mechanical spring, wherein an end of the mechanical spring is hinged with the connector or the lower connecting arm, an other end of the mechanical spring is hinged with a threaded sliding block, the threaded sliding block sleeves on a threaded rod, the threaded rod is arranged in the base, so that when an end part of the threaded rod is operated to drive the threaded rod to rotate, the threaded sliding block is movable along the threaded rod, and a position of the threaded sliding block on the threaded rod is adjusted according to a weight of the display on the connector, so that when the connector is moved upwards or downwards, the connector is stopped at different heights relative to the base.

2. The display support having the freely adjustable height as claimed in claim 1, wherein the display support satisfies a first balance condition and a second balance condition, and the first balance condition is: maintaining the connector at any height within a preset height range, driving the threaded sliding block to move by driving the threaded rod to rotate, and ensuring that a gravitational torque M1 is equal to an elastic torque M2, so as to adapt to the display of any weight within a preset weight range; and the second balance condition is: according to the first balance condition, maintaining a position of the threaded sliding block corresponding to the weight of the display in the threaded rod, and when the height of the connector is arbitrarily changed within the preset height range, ensuring that the gravitational torque M1 is equal to the elastic torque M2, so that the connector is able to stop at different heights relative to the base.

3. The display support having the freely adjustable height as claimed in claim 1, wherein the threaded rod is set to be consistent with a movement trajectory of the threaded siding block, the movement trajectory of the threaded sliding block is a line segment formed by connecting a point e₀ and a point f₀ within a range of a quadrilateral e₁f₁f₂e₂, the range of the quadrilateral e₁f₁f₂e₂ is formed by translating a line segment of upwards and downwards for 5 mm in a direction perpendicular to the line segment ef, so as to obtain line segments e₁f₁ and e₂f₂ respectively, a point e and a point f are respectively intersection points of a circle C with a straight line La and a straight line Lb, a connecting point between the mechanical spring and the connector or the lower connecting arm is taken as a center of circle of the circle C, a length L1 of the mechanical spring when the connector is at a preset maximum height is taken as a radius of the circle C, and the straight lines La and Lb are respectively straight lines where the mechanical spring is located when an included angle b between the mechanical spring and the upper connecting arm or the lower connecting arm is at a maximum value and a minimum value.

4. The display support having the freely adjustable height as claimed in claim 1, wherein an included angle between the threaded rod and a horizontal direction away from the connector is 0-80°.

5. The display support having the freely adjustable height as claimed in claim 1, wherein when the connector is at a preset maximum height, a length L1 of the mechanical spring is set to be L-x, wherein L represents a distance from a connecting point between the mechanical spring and the connector or the lower connecting arm to a hinge point between the lower connecting arm and the base, and x is −10 mm-30 mm.

6. The display support having the freely adjustable height as claimed in claim 1, wherein when the connector is maintained at any horizontal height within a preset height range, according to a maximum value and a minimum value of a preset weight range of the display, a maximum value and a minimum value of an included angle b between the mechanical spring and the upper connecting arm or the lower connecting arm are obtained.

7. The display support having the freely adjustable height as claimed in claim 1, wherein an elastic coefficient K of the mechanical spring is Kmin−Kmax, wherein Kmax−Kmin≤15, and Kmin and Kmax are obtained by a following formula:
$$K = ( \frac{G cos ( a 1 )}{sin ( b 1 )} - \frac{G cos ( a 2 )}{sin ( b 2 )} ) / ( L 1 - L {1}^{′} )$$
in the formula, G represents a weight of the display;
a1 and a2 respectively represent angles between the upper connecting arm or the lower connecting arm and a horizontal plane when the connector is at two arbitrary heights within a preset height range;
b1 and b2 respectively represent included angles between the mechanical spring corresponding to
a1, a2 and the upper connecting arm or the lower connecting arm; and
L1 and L1′ respectively represent lengths of the mechanical spring corresponding to a1 and a2.

8. The display support having the freely adjustable height as claimed in claim 1, wherein an end of the threaded rod is set to be an operating end, and an other end of the threaded rod is rotatably arranged in a mounting seat, so that the threaded rod is driven to rotate by applying a force to the operating end.

9. The display support having the freely adjustable height as claimed in claim 1, wherein the display support comprises an adjusting rod, an end of the adjusting rod is hinged with the connector or the lower connecting arm, an other end of the adjusting rod is in threaded connection with the end of the mechanical spring, and when an end part of the adjusting rod is operated to drive the adjusting rod to rotate, the mechanical spring is driven to expand and contract, so as to adjust an elastic force of the mechanical spring and adapt to the display within a preset weight range.

10. A display support having a freely adjustable height, wherein the display support comprises a base and a connector for installing a display, an upper connecting arm and a lower connecting arm, which are parallel to each other and are arranged between the base and the connector, a parallelogram structure is formed among a hinge point between the upper connecting arm and the connector, the connector, a hinge point between the lower connecting arm and the connector, the lower connecting arm, a hinge point between the lower connecting arm and the base, the base, a hinge point between the upper connecting arm and the base, and the upper connecting arm, the display support further comprises an elastic force balance mechanism, an end of the elastic force balance mechanism is hinged with the upper connecting arm, an other end of the elastic force balance mechanism is hinged with the connector, and an elastic force of the elastic force balance mechanism is adjusted according to the display on the connector, so that when the connector is moved upwards or downwards, the connector is stopped at different heights relative to the base.

11. The display support having the freely adjustable height as claimed in claim 10, wherein the elastic force balance mechanism comprises an elastic member and an adjusting rod, an end of the adjusting rod is hinged with the upper connecting arm, an other end of the adjusting rod is in threaded connection with an end of the elastic member, an other end of the elastic member is connected with the connector, and when an end part of the adjusting rod is operated to drive the adjusting rod to rotate, the elastic member is driven to expand and contract, so as to make an elastic force of the elastic member match the weight of the display on the connector.

12. The display support having the freely adjustable height as claimed in claim 11, wherein an end part of the upper connecting arm is provided with an operating hole, the end part of the adjusting rod is installed in the operating hole, and the end part of the adjusting rod is operated by the operating hole.

13. The display support having the freely adjustable height as claimed in claim 10, wherein both the upper connecting arm and the lower connecting arm are respectively hinged with the base and the connector by connecting shafts and shaft holes matching the connecting shafts.

14. A balance device for realizing adjustable load-bearing of a support, wherein the device comprises a base, a mechanical spring and a connector for installing a display, an upper arm plate and a lower arm plate are arranged between the base and the connector, a quadrilateral structure is formed among a hinge point between the upper arm plate and the connector, the connector, a hinge point between the lower arm plate and the connector, the lower arm plate, a hinge point between the lower arm plate and the base, the base, a hinge point between the upper arm plate and the base, and the upper arm plate, and an end of the mechanical spring is hinged with the base.

15. The balance device for realizing adjustable load-bearing of the support as claimed in claim 14, wherein the device further comprises a threaded sliding block and a threaded rod, the other end of the mechanical spring is hinged with the threaded sliding block, the threaded sliding block sleeves on the threaded rod, the threaded rod is installed on the connector, and when an end part of the threaded rod is operated to drive the threaded rod to rotate, the threaded sliding block is movable along the threaded rod.

16. The balance device for realizing adjustable load-bearing of the support as claimed in claim 15, wherein a position of the threaded sliding block on the threaded rod is adjustable, according to a weight of the display connected with the connector, so that when the connector is moved upwards or downwards, the connector is adjusted to stop at different heights relative to the base.

17. The balance device for realizing adjustable load-bearing of the support as claimed in claim 15, wherein the lower arm plate is provided with a convex block, and the upper arm plate is provided with a groove corresponding to the convex block.

18. The balance device for realizing adjustable load-bearing of the support as claimed in claim 14, wherein the device further comprises threads and a locking screw, an other end of the mechanical spring is hinged with the connector or the lower arm plate, the locking screw is matched with the threads, the threads are arranged in a hinge hole of the upper arm plate and the base or the upper arm plate and the connector; or a hinge hole of the lower arm plate and the base or the connector, and a hinge manner between the upper arm plate and the base, between the upper arm plate and the connector, between the lower arm plate and the base, and between the lower arm plate and the connector is a locking screw connection, or a riveting connection.
